(19) United States
(12) Patent Application Publication
(10) Pub. No.: US 2025/0087701 A1
(43) Pub. Date: Mar. 13, 2025

(54) COMPOSITIONS FOR ELECTRODES

(71) Applicant: MOMENTIVE PERFORMANCE MATERIALS INC., Niskayuna, NY (US)

(72) Inventors: Kartick Bindumadhavan, Bengaluru (IN); Karthikeyan Sivasubramanian, Bangalore (IN); Diao Cheng, White Plains, NY (US); Monjit Phukan, West Harrison, NY (US)

(21) Appl. No.: 18/829,501

(22) Filed: Sep. 10, 2024

(30) Foreign Application Priority Data
Sep. 11, 2023 (IN) 202311061020

(51) Int. Cl. H01M 4/62; C08K 3/04; C08K 3/34; C08K 5/544; C08L 9/06; H01M 10/0525

(52) U.S. Cl. CPC H01M 4/628; C08K 3/042; C08K 3/34; C08K 5/5477; C08L 9/06; C08K 2201/001; H01M 10/0525

(57) ABSTRACT

A composition suitable for an electrochemical device is shown and described herein. The composition comprises an organofunctional material with a nitrogen functional group. In aspects the nitrogen functional group is a ureido functional group. The composition can be employed in the electrodes materials employed in an electrochemical cell such as, for example, a lithium battery.

### CROSS REFERENCE TO RELATED APPLICATIONS

The present application claims priority to and the benefit of India Provisional Application 20/231,1061020 filed on Sep. 11, 2023, the disclosure of which is incorporated herein by reference in its entirety.

### FIELD OF INVENTION

The present invention relates to compositions for electrodes. In particular, the present invention relates to compositions comprising ureido functional compounds as additives and compositions suitable for use in forming electrodes.

### BACKGROUND

With the increased use of batteries in various applications, e.g., electric vehicles, consumable electronics, etc., the demand for development and improvement of energy generation and energy storage devices continues to increase. Manufacturers are looking to provide improved properties in batteries such as high capacity, fast charging, long range, high shelf life, etc. These properties are directly influenced by the electrochemical reactions occurring inside the cells.

Graphite is a common material for negative electrode materials. Graphite has an irreversible capacity of 372 mAh g-1. This limited capacity may hinder its application in next generation high-capacity batteries for long term use on a single charge.

Lithium batteries are of great interest and use in the industry. One manner to improve the capacity of lithium batteries is to dope or develop composites with high capacity materials and graphite. Potential negative electrode materials include oxides, carbides, and/or nitrides of tin, germanium, and/or silicon. Silicon and silicon-based anode materials are of particular interest due to their high specific capacity. These materials are also generally readily available in large quantities. Silicon can demonstrate capacities up to 3700 mAh g-1. Silicon monoxide can provide capacities around 1850 mAh g-1.

Silicon materials, however, have high expansion characteristics during lithiation. Silicon can expand up to 400% in volume compared to its initial dimensions. This can cause cracking of the electrodes and a reduction in capacity. Silicon also undergoes a high degree of pulverization during the reaction with lithium that results in a high amount of irreversible capacity. This also contributes to capacity reduction (or fade) as charging cycles are carried out on the battery.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is compositions suitable for use in an electrode. The composition comprises a nitrogen containing organosilicon material as an additive. In embodiments, the nitrogen containing organosilicon material is a ureido functional organosilicon material. The ureido functional organosilicon materials have been found to provide electrode materials with excellent capacity retention over a large number of charging cycles (i.e., charge/discharge cycles). This is seen at both constant current densities and at varied rates. The materials with the ureido functional organosilicon materials also exhibit excellent capacity recovery after reversing current density. The materials also exhibit low impedance over cycling.

In one aspect, provided is a composition comprising:
(a) a polymeric resin,
(b) a compound represented by formula (I)

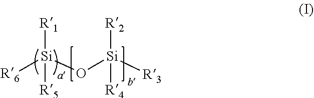

where R¹′, R²′, R³′, R⁴′, R⁵′, and R⁶′ is independently selected from the group consisting of R⁴, OR⁵, and a ureido functional group, where R⁴ is independently selected from a monovalent group selected from the group consisting of a straight chain alkyl having 1 to 12 carbon atoms, a branched chain alkyl having 3 to 12 carbon atoms, a cycloalkyl having 5 to 12 carbon atoms, an alkyenyl having 2 to 12 carbon atoms, an aryl group having 6 to 20 carbon atoms, and an aralkyl having 7 to 20 carbon atoms; R⁵ is independently selected from a monovalent group selected from the group consisting of a straight chain alkyl having 1 to 12 carbon atoms, a branched chain alkyl having 3 to 12 carbon atoms, a cycloalkyl having 5 to 12 carbon atoms, an alkyenyl having 2 to 12 carbon atoms, an aryl group having 6 to 20 carbon atoms, an aralkyl having 7 to 20 carbon atoms; a′ or b′ is 0-500 with the proviso that at least one of these a′ or b′ is >0; and at least one R¹′, R²′, R³′, R⁴′, R⁵′, and/or R⁶′ is a ureido functional group;
wherein the ureido functional group is represented by the formula:

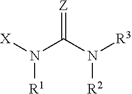

where R¹ and R² are each independently selected from the group consisting of hydrogen and a monovalent organic group having 1 to 20 carbon atoms;
R³ is a divalent straight chain alkylene group having 1 to 20 carbon atoms, or a divalent branched alkylene group having 3 to 20 carbon atoms, each of which optionally contains one or more heteroatoms within the chain; X is selected from the group consisting of a substituted or unsubstituted aromatic group having 6 to 20 carbon atoms and a heterocyclic group containing 1 to 20 heteroatoms, wherein the aromatic group and/or the heterocyclic group are optionally substituted with an alkyl group having from 1 to 12 carbon atoms optionally containing a heteroatom selected from the group consisting of O, N, and/or S and a ureido functional group; and wherein Z is oxygen;
(c) an electrode active agent; and (d) optionally a binding agent.

In one embodiment, the polymeric resin is selected from one or more of a group consisting of polyethylene, polypropylene, polyethylene terephthalate, polymethyl methacrylate, aromatic polyamide, chitosan, alginic acid, polyacrylic acid, polyimide, cellulose, carboxy methyl cellulose, nitro cellulose; Styrene-butadiene rubber (SBR), isoprene rubber, butadiene rubber, fluoroelastomers, acrylonitrile-butadiene rubber (NBR), ethylene-propylene rubber; styrene-butadiene-styrene block copolymers and hydrogenated products thereof; EPDM (ethylene-propylene-diene terpolymers), styrene-ethylene-butadiene-styrene copolymers, styrene-isoprene-styrene block copolymers and hydrogenated products thereof; syndiotactic-1,2-polybutadiene, polyvinyl acetate, ethylene-vinyl acetate copolymers, and propylene-α-olefin copolymers; polyvinylidene fluoride, polytetrafluoroethylene, vinylidene fluoride copolymer, and tetrafluoroethylene-ethylene copolymers; and polymer containing alkali metal ions.

In one embodiment in accordance with any of the previous embodiments, the optional binding agent is selected from one or more of a group consisting of carboxymethyl cellulose, methyl cellulose, hydroxymethyl cellulose, ethyl cellulose, polyvinyl alcohol, oxidized starch, monostarch phosphate, casein, polyvinylpyrrolidone, salts thereof.

In one embodiment in accordance with any of the previous embodiments, the electrode active agent is selected from the group consisting of one or more of an intercalating agent and a conductive agent. In one embodiment, the intercalating agent is selected from the group consisting of graphite, lithium nickel manganese cobalt oxide (LiNMC), Si, SiB₄, SiB₆, Mg₂Si, Ni₂Si, TiSi₂, MoSi₂, CoSi₂, NiSi₂, CaSi₂, CrSi₂, Cu₆Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, Sn, SnSiO₃, LiSnO, and Mg₂Sn, SnO_{w} (0<w≤2).

In one embodiment, the conductive agent is a carbonaceous conductive agent selected from the group consisting of graphite, including natural graphite, artificial graphite, carbon black, including acetylene black, Ketjen black, channel black, furnace black, lamp black, thermal black, amorphous carbon, including needle coke, carbon nanotube, fullerene, and vapor-phase grown carbon fibers (VGCF).

In one embodiment in accordance with any of the previous embodiments, a′>0 with the proviso that b′-0, and the compound represented by the formula 1 is a polysilane.

In one embodiment in accordance with any of the previous embodiments, the compound of formula (I) has the formula:

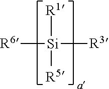

where R¹′, R³′, R⁵′, and R⁶′ are each independently selected from R⁴, OR⁵, and a ureido functional group, where R⁴ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
R⁵ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
a′ is 1-500; and
at least one of R¹′, R³′, R⁵′, and R⁶′ is selected from a ureido functional group.

In one embodiment in accordance with any of the previous embodiments, b′>0 with the proviso that a′=0, and the compound represented by the formula 1 is a polysiloxane.

In one embodiment in accordance with any of the previous embodiments, the compound represented by the formula 1 is a ureido functional organosilicon.

In one embodiment in accordance with any of the previous embodiments, the ureido functional organosilicon is a compound of the formula:

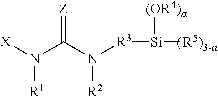

where,
R¹ and R² are each independently hydrogen or a monovalent organic group having 1 to 20 carbon atoms;
R³ is a divalent straight chain alkylene group having 1 to 20 carbon atoms, or a divalent branched alkylene group having 3 to 20 carbon atoms, each of which optionally contains one or more heteroatoms within the chain;
R⁴ is independently a monovalent group selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
R⁵ is independently selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
X is an aromatic group having 6 to 20 carbon atoms or a heterocyclic group containing up to 20 heteroatoms, wherein the aromatic group or the heterocyclic group is optionally substituted with an alkyl group having from 1 to 12 carbon atoms optionally containing a heteroatom selected from the group consisting of O, N, and/or S, and a ureido functional group:
Z is oxygen; and
a is an integer having the value 1, 2, or 3.

In one embodiment in accordance with any of the previous embodiments, the compound of formula (I) is a polysiloxane represented by the formula:

M¹ₐM²_{b}D¹_{c}D²ₐT¹ₑT²_{f}Q_{g}
where:
M¹ is (R¹⁶)(R¹⁷)(R¹⁸)SiO_{1/2}
M² is (R¹⁹)(R²⁰)(R²¹)SiO_{1/2}
D¹ is (R²²)(R²³)SiO_{2/2}
D² is (R²⁴)(R²⁵)SiO_{2/2}
T¹ is (R²⁶)SiO_{3/2}
T² is (R²⁷)SiO_{3/2}
Q is SiO_{4/2}
R¹⁶, R¹⁷, R¹⁸, R²², R²³, and R²⁶ are independently selected from the group consisting of R⁴ and OR⁵;
R¹⁹, R²⁰, R²¹, R²⁴, R²⁵, and R²⁷ are independently selected from the group consisting of R⁴, OR⁵ and a ureido functional group, with the proviso that at least one of R¹⁹, R²⁰, R²¹, R²⁴, R²⁵, and R²⁷ is a ureido functional group;
where R⁴ is independently selected from the group consisting of a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
R⁵ is independently selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
b, d, and f are independently an integer greater than 0; and
a, c, e, and g are each independently an integer greater than 0.

In one embodiment in accordance with any of the previous embodiments, X is a six membered ring comprising up to 5 nitrogen atoms.

In one embodiment in accordance with any of the previous embodiments, X is a six membered ring comprising 1 or 2 nitrogen atoms.

In one embodiment in accordance with any of the previous embodiments, X is selected from

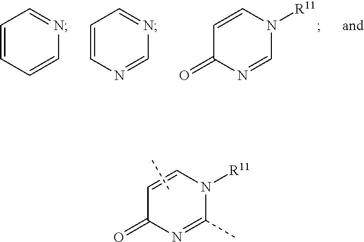

where R¹¹ is selected from the group consisting of hydrogen and a monovalent organic group having 1 to 12 carbon atoms.

In one embodiment in accordance with any of the previous embodiments, X is

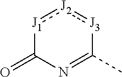

where J₁, J₂, and J₃ are each independently a substituted or unsubstituted C or N atom, the dashed lines between J₁, J₂, and J₃ indicate an optional double bond between J₁ and J₂ or J₂ and J₃.

In one embodiment in accordance with any of the previous embodiments, the substituent in X is represented by the formula:

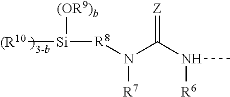

where R⁶ and R⁷ are each independently hydrogen or a monovalent organic group having 1 to 20 carbon atoms;
R⁸ is a divalent straight chain alkylene group having 1 to 20 carbon atoms, or a divalent branched alkylene group having 3 to 20 carbon atoms, each of which can optionally contain one or more heteroatoms within the chain;
R⁹ is each independently selected from the group consisting of a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
R¹⁰ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms; and wherein b is an integer having a value 1, 2, or 3.

In one embodiment in accordance with any of the previous embodiments, the ureidofunctional organosilicon is represented by the formula:

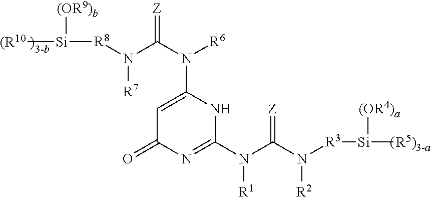

In one embodiment in accordance with any of the previous embodiments, the compound represented by the formula 1 is present in an amount of about 0.1 to 10 wt. % based on the total weight of the composition.

In one embodiment in accordance with any of the previous embodiments, the compound of the formula 1 is present in an amount of from about 0.01 wt. % to about 90 wt. %, from about 0.05 wt. % to about 80 wt. %, from about 0.1 wt. % to about 75 wt. %, from about 0.2 wt % to about 60 wt. %, from about 0.5 wt. % to about 50 wt. %, from about 1 wt. % to about 25 wt. %, or from about 5 wt. % to about 10 wt. % based on the total weight of the composition; preferably 1-10 wt %, 10-50 wt % or 50-90 wt %, based on the total weight of the composition.

In one embodiment in accordance with any of the previous embodiments, the composition is a solventless composition.

In one aspect, provided is an energy storage device comprising: (a) at least one electrode; and (b) an electrolyte, wherein the at least one electrode comprises the composition of any one of the previous embodiments.

In one embodiment, the device has a specific capacity as determined by cycling stability study, after at least 500 electrochemical cycles, of at least 20% of its specific capacity after the first cycle. In one embodiment in accordance with any of the previous embodiments, the device has a specific capacity as determined by cycling stability study, after at least 500 electrochemical cycles, of at least 40% of its specific capacity after the first cycle. In one embodiment in accordance with any of the previous embodiments, the device has specific capacity as determined by cycling stability study, after at least 500 electrochemical cycles, of at least 60% of its specific capacity after the first cycle.

In one embodiment in accordance with any of the previous embodiments, the device is a secondary battery.

In one embodiment in accordance with any of the previous embodiments, the secondary battery is a Lithium ion battery.

In still another aspect, provided is an energy storage device comprising: at least one electrode and an electrolyte wherein the at least one electrode comprises: (a) a polymeric resin; (b) a capacity retaining agent; (c) an electrode active agent; and (d) optionally a binding agent, wherein the capacity retaining agent retains the specific capacity of the electrode, after 500 electrochemical cycles, in the range of 20-80% of its specific capacity after the first cycle.

In one embodiment, the capacity retaining agent is represented by the formula:

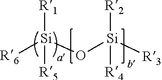

where R¹′, R²′, R³′, R⁴′, R⁵′, and R⁶′ are each independently R⁴, OR⁵, or a ureido functional group, where R⁴ is independently a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, or an aralkyl having 7 to 20 carbon atoms;
R⁵ is independently a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, or an aralkyl having 7 to 20 carbon atoms;
a′ or b′ is an integer having a value in the range of 0-500, with the proviso that at least one of these
a′ or b′ is >0; and
at least one of R¹′, R²′, R³′, R⁴′, R⁵′, and/or R⁶′ is a ureido functional group.

In one embodiment, wherein the ureido functional group is represented by the formula:

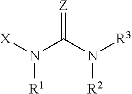

where R¹ and R² are each independently selected from the group consisting of hydrogen and a monovalent organic group having 1 to 20 carbon atoms;
R³ is a divalent straight chain alkylene group having 1 to 20 carbon atoms, or a divalent branched alkylene group having 3 to 20 carbon atoms, each of which optionally contains one or more heteroatoms within the chain;
X is selected from the group consisting of a substituted or unsubstituted aromatic group having 6 to 20 carbon atoms and a heterocyclic group containing 1 to 20 heteroatoms, wherein the aromatic group and/or the heterocyclic group are optionally substituted with an alkyl group having from 1 to 12 carbon atoms optionally containing a heteroatom selected from the group consisting of O, N,
and/or S and a ureido functional group; and
Z is oxygen.

In a further aspect, provided is an electrode comprising the composition of any one of the previous embodiments.

In yet another aspect, provided is an electrochemical cell comprising a negative electrode, and a positive electrode, wherein the negative electrode, the positive electrode, or both the negative and positive electrode comprise the composition of claims 1-21.

In one embodiment, the electrochemical cell further comprises a separator.

In one embodiment in accordance with any of the previous embodiments, the electrochemical cell is a lithium ion battery.

In another aspect, provided is an energy storage device comprising: (a) at least one electrode; and (b) an electrolyte, wherein the at least one electrode comprises the composition.

In another aspect, provided is an electrode comprising the composition as shown and described.

In yet another aspect, provided is an electrochemical cell comprising a negative electrode, and a positive electrode, wherein the negative electrode, the positive electrode, or both the negative and positive electrode comprise the composition as shown and described.

In still another aspect, provided is energy storage device comprising: at least one electrode and an electrolyte wherein the at least one electrode comprises: (a) a polymeric resin; (b) a capacity retaining agent; (c) an electrode active agent; and (d) optionally a binding agent, wherein the capacity retaining agent retains the specific capacity of the electrode, after 500 electrochemical cycles, in the range of 20-80% of its specific capacity after the first cycle

The following drawings description disclose a various illustrative aspect. Some improvements and novel aspects may be expressly identified, while others may be apparent from the description and drawings.

### BRIEF DESCRIPTION OF THE DRAWINGS

FIG. 1 is a cyclic voltammogram of a cell employing a composition with a ureido functional organosilicon material;

FIG. 2 is a cyclic voltammogram of a cell employing a control binder without the ureido functional organosilicon material; and

FIG. 3 is a galvanostatic charge/discharge curve at various numbers of cycles.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided herein are compositions suitable for use in an electrode, wherein the composition comprises a polymeric resin, a compound, an electrode active agent, and optionally a binding agent. The compound is a ureido functional organsilicon material.

In one embodiment, the ureido functional organosilicon material comprises a ureido functional silane. In another embodiment, the ureido functional organosilicon material comprises a ureido functional siloxane. The ureido functional organosilicon material is suitable for use as binding additive in an electrode composition that may be employed in configuring an electrochemical cell such as battery. The ureido functional organosilicon material can be mixed with polymeric resin, electrode active agent, and binding agent to form a composition useful for a positive or negative electrode.

The composition comprises a ureido functional organosilicon material as an additive. The ureido functional organosilicon may be represented by a compound of formula (I):

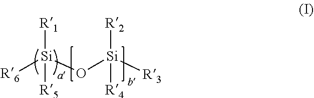

wherein R¹′, R²′, R³′, R⁴′, R⁵′, and R⁶′ is each independently selected from the group consisting of R⁴, OR⁵, and a ureido functional group, where R⁴ is independently selected from a monovalent group selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms; R⁵ is independently selected from a monovalent group selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, an aralkyl having 7 to 20 carbon atoms; a′ or b′ is 0-500 with the proviso that at least one of these a′ or b′ is >0; and at least one of R1′ to R6′ is a ureido functional group. It will be appreciated that when a′ is greater than 0, then b′ is 0, and when b′ is greater than 0, a′ is 0.

The ureido functional group is of the formula:

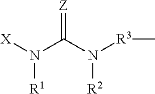

where R¹ and R² are each independently selected from hydrogen or a monovalent organic group having 1 to 20 carbon atoms;
R³ is a divalent straight chain alkylene group having 1 to 20 carbon atoms, or a divalent branched alkylene group having 3 to 20 carbon atoms, each of which can optionally contain one or more heteroatoms within the chain;
X is selected from an aromatic group having 6 to 20 carbon atoms, a heterocyclic group containing 5 to 20 heteroatoms, wherein the aromatic group and/or the heterocyclic group are optionally substituted with an alkyl group having from 1 to 12 carbon atoms optionally containing a heteroatom selected from O, N, and/or S, or a ureido functional group; and
Z is oxygen.

In one embodiment, the ureido functional organosilicon material is a silane (b′ is 0) of the formula:

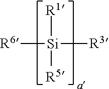

where R¹′, R³′, R⁵′, and R⁶′ are each independently selected from R⁴, OR⁵, and a ureido functional group, where R⁴ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
R⁵ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
a′ is 1-500; and
at least one of R¹′, R³′, R⁵′, and R⁶′ is selected from a ureido functional group.

In one embodiment, R⁶′ is a ureido functional group, and R¹′, R³′, and R⁵′ are each independently selected from R⁴ and OR⁵.

In one embodiment, the ureido functional organosilicon material is a silane selected from a compound of formula:

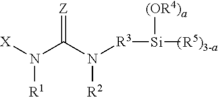

where R¹ and R² are each independently selected from hydrogen or a monovalent organic group having 1 to 20 carbon atoms;
R³ is a divalent straight chain alkylene group having 1 to 20 carbon atoms, or a divalent branched alkylene group having 3 to 20 carbon atoms, each of which can optionally contain one or more heteroatoms within the chain;
R⁴ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
R⁵ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
X is selected from an aromatic group having 6 to 20 carbon atoms, a heterocyclic group containing up to 20 heteroatoms, wherein the aromatic group and/or the heterocyclic group are optionally substituted with an alkyl group having from 1 to 12 carbon atoms optionally containing a heteroatom selected from O, N, and/or S, or a ureido functional group:
Z is oxygen; and a is 1, 2, or 3,
n is 1 to 500.
R¹ and R² are each independently selected from hydrogen, a monovalent group having 1 to 20 carbon atoms, 2 to 15 carbon atoms, 4 to 12 carbon atoms, or 6 to 10 carbon atoms. Examples of suitable monovalent organic groups include, but are not limited to, methyl, ethyl, propyl, isopropyl, butyl, isobutyl, pentyl, hexyl, heptyl, octyl, nonyl, decyl, and the like. In one embodiment, R¹ and R² are each independently selected from hydrogen and a monovalent group having 1 to 4 carbon atoms. In one embodiment, R¹ and R² are each hydrogen.

In embodiments, R³ is selected from a divalent straight chain alkylene group containing from 1 to 12 carbon atoms, from 1 to 8 carbon atoms, and from 1 to 4 carbon atoms, or 3 carbon atoms, e.g. (—CH2-)3.

In embodiments, R⁴ is independently a monovalent group selected from a straight chain alkyl containing from 1 to 8 carbon atoms, 1 to 4 carbon atoms, or 1 to 2 carbon atoms, or a branched chain alkyl containing from 3 to 8 carbon atoms, 4 to 6 carbon atoms, or 3 to 4 carbon atoms. Examples of suitable R⁴ groups include, but are not limited to, methyl, ethyl, propyl, isopropyl, butyl, isobutyl, and the like, a cycloalkyl containing 6 carbon atoms, an alkenyl containing from 2 to 8 carbon atoms, preferably from 2 to 4 carbon atoms, an aryl group, e.g., phenyl, an aralkyl containing from 7 to 10 carbon atoms, preferably from 7 to 9 carbon atoms, a straight chain alkyl containing 2 to 8 carbon atoms and a hydroxyl group, preferably from 2 to 4 carbon atoms and a hydroxyl group, or a branched chain alkyl containing 3 or 4 carbon atoms and a hydroxyl group.

R⁵ is independently a monovalent group selected from a straight chain alkyl containing from 1 to 8 carbon atoms, from 1 to 4 carbon atoms, or from 1 to 2 carbon atoms, a branched chain alkyl containing from 3 to 8 carbon atoms, from 3 to 6 carbon atoms, or from 3 to 4 carbon atoms, a cycloalkyl containing 6 carbon atoms, an alkenyl group containing from 2 to 8 carbon atoms, or from 2 to 6 carbon atoms, an aryl group such as phenyl, or an aralkyl group containing from 7 to 10 carbon atoms, or from 7 to 9 carbon atoms.

In one embodiment, X is selected from an aromatic group containing 6 carbon atoms, e.g., phenyl, or a heterocyclic group containing 6 atoms and up to 5 heteroatoms. X can be substituted or unsubstituted. X may be substituted, for example, with an alkyl group having 1 to 12 carbon atoms, 2 to 10 carbon atoms, or 4 to 6 carbon atoms, an alkenyl group having 2 to 12 carbon atoms, a ureido functional group, or a heteroatom selected from N or O. In one embodiment, X is a substituted or unsubstituted phenyl group. In one embodiment, X is a six membered heterocyclic group containing 1- to 5 heteroatoms selected from nitrogen, 3 heteroatoms selected from nitrogen, or 1 or 2 heteroatoms selected from nitrogen.

In one embodiment, X is selected from a group of the formula:

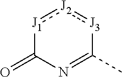

where J₁, J₂, and J₃ are each independently a substituted or unsubstituted C or N atom, the dashed lines between J₁, J₂, and J₃ indicate an optional double bond between J₁ and J₂ or J₂ and J₃. When any of J₁, J₂, or J₃ is a substituted N atom, then that atom does not participate in a double bond.

Some non-limiting examples of X include:

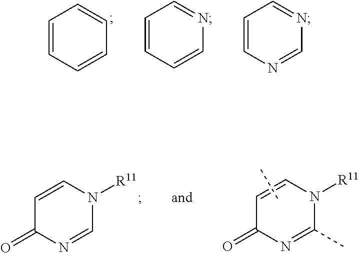

where R¹¹ is selected from hydrogen and a monovalent organic group having 1 to 12 carbon atoms.

X can be substituted with an alkyl group having from 1 to 12 carbon atoms, 2 to 10 carbon atoms, or 4 to 6 carbon atoms, or a ureido functional group. The alkyl groups may optionally contain a heteroatom selected from O, N, and/or S. In one embodiment, the X group is substituted with a ureido functional group of the formula:

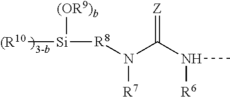

where R⁶ and R⁷ are each independently selected from hydrogen or a monovalent organic group having 1 to 20 carbon atoms;
R⁸ is a divalent straight chain alkylene group having 1 to 20 carbon atoms, or a divalent branched alkylene group having 3 to 20 carbon atoms, each of which can optionally contain one or more heteroatoms within the chain;
R⁹ is each independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
R¹⁰ is each independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms; and
b is 1, 2, or 3.
R⁶ and R⁷ are each independently selected from hydrogen, a monovalent group having 1 to 20 carbon atoms, 2 to 15 carbon atoms, 4 to 12 carbon atoms, or 6 to 10 carbon atoms. Examples of suitable monovalent organic groups include, but are not limited to, methyl, ethyl, propyl, isopropyl, butyl, isobutyl, pentyl, hexyl, heptyl, octyl, nonyl, decyl, and the like. In one embodiment, R⁶ and R⁷ are independently selected from hydrogen and a monovalent group having 1 to 4 carbon atoms. In one embodiment, R⁶ and R⁷ are each hydrogen.

In embodiments, R⁸ is selected from a divalent straight chain alkylene group containing from 1 to 12 carbon atoms, from 1 to 8 carbon atoms, from 1 to 4 carbon atoms, or 3 carbon atoms, e.g. (—CH2-)3.

In embodiments, R⁹ is each independently a monovalent group selected from a straight chain alkyl containing from 1 to 8 carbon atoms, 1 to 4 carbon atoms, or 1 to 2 carbon atoms, or a branched chain alkyl containing from 3 to 8 carbon atoms, or 3 to 4 carbon atoms. Examples of suitable groups for R⁹ include, but are not limited to, methyl, ethyl, propyl, isopropyl, butyl, isobutyl and the like, a cycloalkyl containing 6 carbon atoms, an alkenyl containing from 2 to 8 carbon atoms, preferably from 2 to 4 carbon atoms, an aryl group, e.g., phenyl, or aralkyl containing from 7 to 10 carbon atoms, preferably from 7 to 9 carbon atoms, a straight chain alkyl containing 2 to 8 carbon atoms and a hydroxyl group, a straight chain alkyl containing 2 to 4 carbon atoms and a hydroxyl group, or a branched chain alkyl containing 3 or 4 carbon atoms and a hydroxyl group.

R¹⁰ is independently a monovalent group selected from a straight chain alkyl containing from 1 to 8 carbon atoms, from 1 to 4 carbon atoms, or 1 to 2 carbons, a branched chain alkyl containing from 3 to 8 carbon atoms, or from 3 to 4 carbon atoms, a cycloalkyl containing 6 carbon atoms, an alkenyl group containing from 2 to 8 carbon atoms, more preferably from 2 to 6 carbon atoms, an aryl group such as phenyl, or an aralkyl group containing from 7 to 10 carbon atoms, or from 7 to 9 carbon atoms.

In one embodiment of formula (I), R¹ and R² are each H, Z is O, R³ is a divalent straight chain alkylene group containing from 2 to 6 carbon atoms, the subscript a is 3, and each R⁴ is a straight chain alkyl group containing from 1 to 3 carbon atoms.

In another embodiment of formula (I), X is a phenyl group, R¹ and R² are each H, Z is O, Z is a divalent straight chain alkylene group containing from 2 to 6 carbon atoms, the subscript a is 3, and each R⁴ is a straight chain alkyl group containing from 1 to 3 carbon atoms.

In another embodiment of formula (I), X is a heterocyclic group containing 1 or 2 N atoms, R¹ and R² are each H, Z is O, R³ is a divalent straight chain alkylene group containing from 2 to 6 carbon atoms, the subscript a is 3, and each R⁴ is a straight chain alkyl group containing from 1 to 3 carbon atoms.

In another embodiment of formula (I), X is a heterocyclic group containing 2 N atoms, and the ring is substituted with an O atom, R¹ and R² are each H, Z is O, R³ is a divalent straight chain alkylene group containing from 2 to 6 carbon atoms, the subscript a is 3, and each R⁴ is a straight chain alkyl group containing from 1 to 3 carbon atoms.

In another embodiment of formula (I), X is a heterocyclic group containing 2 N atoms, where the ring is substituted with an O atom in the form of a carbonyl O, and an alkyl group containing 1 or 2 carbon atoms, R¹ and R² are each H, Z is O, R³ is a divalent straight chain alkylene group containing from 2 to 6 carbon atoms, the subscript a is 3, and each R⁴ is a straight chain alkyl group containing from 1 to 3 carbon atoms.

In one embodiment, the ureido functional organosilicon is a ureido functional silane (i.e, a compound of formula 1 where a′ is greater than 0, and b′ is 0) selected from a compound of the formula:

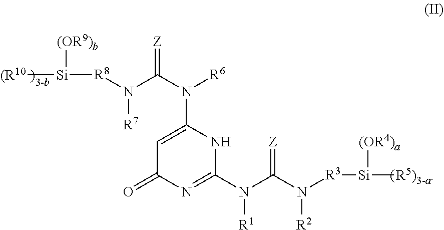

Some non-limiting examples of suitable ureido functional organosilicon include the ureido functional silanes represented by:

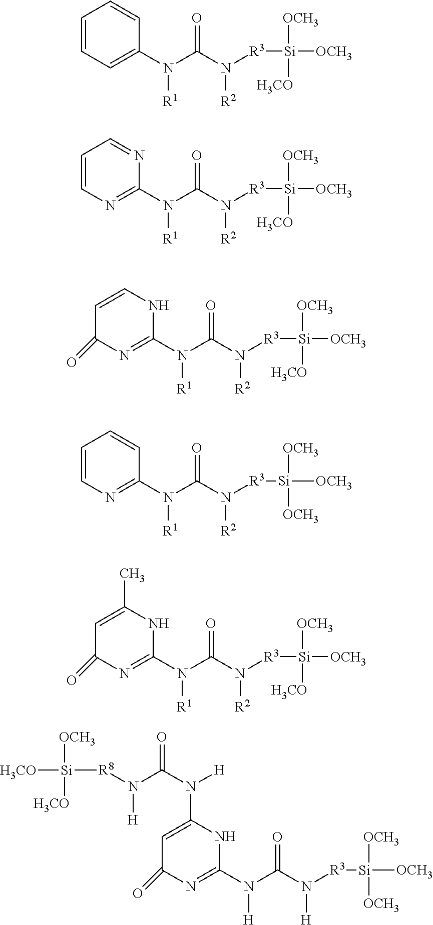

where R¹ and R² are each independently selected from H and an alkyl grove with 1 to 12 carbons, 1 to 6 carbons, or 1 to 4 carbons, and R³ and R⁸ are as described above, and in embodiments is selected from a C1-12 alkylene, a C2-C10 alkylene, a C₃-C₈ alkylene, or a C4-C6 alkylene. In embodiment, R¹ and R² are each H, and R³ and R⁸ are each a C3 alkylene.

In one embodiment, the ureido functional material is a ureido functional polyorganosiloxane (i.e, a compound of formula 1 where b′ is greater than 0, and a′ is 0) of the formula:

M¹_{c}M²_{d}D¹ₑD²_{f}T¹_{g}T²ₕQᵢ
where:
M¹ is (R¹⁶)(R¹⁷)(R¹⁸)SiO_{1/2}
M² is (R¹⁹)(R²⁰)(R²¹)SiO_{1/2}
D¹ is (R²²)(R²³)SiO_{2/2}
D² is (R²⁴)(R²⁵)SiO_{2/2}
T¹ is (R²⁶)SiO_{3/2}
T² is (R²⁷)SiO_{3/2}
Q is SiO_{4/2}
R¹⁶, R¹⁷, R¹⁸, R²², R²³, and R²⁶ are each independently selected from R⁴ and OR⁵;
R¹⁹, R²⁰, R²¹, R²⁴, R²⁵, and R²⁷ are each independently selected from R⁴, OR⁵ and a ureido functional group, with the proviso that at least one of R¹⁹, R²⁰, R²¹, R²⁴, R²⁵, and R²⁷ are selected from a ureido functional group;
where R⁴ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
R⁵ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
d, f and h are each independently greater than 0; and
c, e, g, and i are each independently 0 or greater.

The composition includes a polymeric resin. The polymeric resin includes, but is not limited to, resin polymers such as polyethylene, polypropylene, polyethylene terephthalate, polymethyl methacrylate, aromatic polyamide, chitosan, alginic acid, polyacrylic acid, polyimide, cellulose, and nitro cellulose; rubbery polymers such as SBR (styrene-butadiene rubber), isoprene rubber, butadiene rubber, fluoroelastomers, NBR (acrylonitrile-butadiene rubber), and ethylene-propylene rubber; styrene-butadiene-styrene block copolymers and hydrogenated products thereof; thermoplastic elastomeric polymers such as EPDM (ethylene-propylene-diene terpolymers), styrene-ethylene-butadiene-styrene copolymers, and styrene-isoprene-styrene block copolymers and hydrogenated products thereof; soft resin polymers such as syndiotactic-1,2-polybutadiene, polyvinyl acetate, ethylene-vinyl acetate copolymers, and propylene-α-olefin copolymers; fluoropolymers such as polyvinylidene fluoride, polytetrafluoroethylene, vinylidene fluoride copolymer, and tetrafluoroethylene-ethylene copolymers; and polymer compositions having ion conductivity of alkali metal ions (especially, lithium ions). The resin may be provided as a single type of resin or as a mixture of two or more resins where a combination of resins is used, the resins may be employed at any ratio for a particular application.

The composition optionally include a binding agent. Examples of optional binding agent include, but is not limited to, carboxymethyl cellulose, methyl cellulose, hydroxymethyl cellulose, ethyl cellulose, polyvinyl alcohol, oxidized starch, monostarch phosphate, casein, polyvinylpyrrolidone, and salts thereof. The optional binding agent can be provided as a single material or combination of two or more thickening agents.

The composition comprises a polymeric resin in an amount of up to about 30 wt. % based on the total weight of the electrode composition. In one embodiment the electrode composition comprises the polymeric resin in an amount of up to about 10 wt. % based on the total weight of the electrode composition. In one embodiment the electrode composition comprises the polymeric resin in an amount of up to about 4 wt. % based on the total weight of the electrode composition.

In embodiments, the composition comprises the ureido functional organosilicon in an amount of from about 0.01 wt. % to about 90 wt. %, from about 0.05 wt. % to about 80 wt. %, from about 0.1 wt. % to about 75 wt. %, from about 0.2 wt. % to about 60 wt. %, from about 0.5 wt. % to about 50 wt. %, from about 1 wt. % to about 25 wt. %, or from about 5 wt. % to about 10 wt. % based on the total weight of the composition.

The composition may further include an electrode active agent, wherein the electrode active agent is selected from the group consisting of an intercalating agent and a conductive agent. The intercalating agent is selected from the group consisting of graphite, lithium nickel manganese cobalt oxide (LiNMC), Si, SiB₄, SiB₆, Mg₂Si, Ni₂Si, TiSi₂, MoSi₂, CoSi₂, NiSi₂, CaSi₂, CrSi₂, Cu₆Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, Sn, SnSiO₃, LiSnO, and Mg₂Sn, SnO_{w} (0<w≤2). In one or more embodiments, the conductive agent is a carbonaceous conductive agent selected from the group consisting of graphite, including natural graphite, artificial graphite, carbon black, including acetylene black, Ketjen black, channel black, furnace black, lamp black, thermal black, amorphous carbon, including needle coke, carbon nanotube, fullerene, and vapor-phase grown carbon fibers (VGCF). The composition may include a single type of conductive agent or two or more conductive agents. The electrode active agent is used in an amount of usually about 0.01% by mass or more, about 0.1% by mass or more, about 1% by mass or more, and usually about 50% by mass or less, about 30% by mass or less, more preferably about 15% by mass or less. The conductive agent in an amount less than the above range may cause insufficient conductivity. In contrast, the conductive agent in an amount more than the above range may cause a low battery capacity.

The ureido functional organosilicon materials have unexpectedly been found to provide electrode materials with excellent capacity retention over a large number of charging cycles (i.e., charge/discharge cycles). This was seen at both constant current densities and at varied rates. The materials with the ureido functional organosilicon materials also exhibited excellent capacity recovery after reversing current density. The materials also exhibit low impedance over cycling. The ureido functional organosilicon materials also enhanced binding properties of the electrode materials.

The compositions can be provided as a slurry in combination with a solvent, or as a “dry,” solventless, material. The solvent for forming a slurry may be any solvent that can dissolve or disperse therein the electrode active material, the conductive material, and the binder, as well as a thickening agent as may be used. The solvent may be either an aqueous solvent or an organic solvent. Examples of the aqueous medium include water and solvent mixtures of an alcohol and water. Examples of suitable organic solvents include, but are not limited to, aliphatic hydrocarbons such as hexane; aromatic hydrocarbons such as benzene, toluene, xylene, and methyl naphthalene; heterocyclic compounds such as quinoline and pyridine; ketones such as acetone, methyl ethyl ketone, and cyclohexanone; esters such as methyl acetate and methyl acrylate; amines such as diethylene triamine and N,N-dimethylaminopropylamine; ethers such as diethyl ether, propylene oxide, and tetrahydrofuran (THF); amides such as N-methylpyrrolidone (NMP), dimethyl formamide, and dimethyl acetamide; and aprotic polar solvents such as hexamethyl phospharamide and dimethyl sulfoxide.

The compositions is suitable for use in an electrochemical device such as, for example, a battery, supercapacitor, fuel cell, hydrogen storage device. The electrode composition can be employed as part of either a positive or negative electrode material. The electrode material generally comprises an electrode active material, e.g., a positive or negative electrode active material as may be appropriate for the desired electrode, the binder agent composition, and a current collector.

The composition with the ureido functional organosilicon has been found to provide large capacity retention over a relatively large number of electrochemical cycles. In one embodiment, the electrode composition retains at least 20% of the initial capacity for up to at least 500 electrochemical cycles in an energy storage device. In one embodiment the electrode composition retains at least 40% of the initial capacity for up to at least 500 electrochemical cycles in an energy storage device. In one embodiment the binder retains at least 60% of the initial capacity for up to at least 500 electrochemical cycles in an energy storage device.

The composition comprises an electrode active material wherein the electrode active material comprises a positive electrode active material or/and a negative electrode active material. The positive electrode active material may be any material that can electrochemically occlude and release lithium ions. Examples of positive electrode active materials include, but are not limited to, lithium-containing transition metal composite oxides, lithium-containing transition metal phosphoric acid compounds, sulfur-based materials, and conductive polymers. Particularly suitable positive electrode active materials are lithium-containing transition metal composite oxides and lithium-containing transition metal phosphoric acid compounds. An exemplary positive electrode active material is a lithium-containing transition metal composite oxide that generates high voltage.

The transition metal of the lithium-containing transition metal composite oxide can be selected from V, Ti, Cr, Mn, Fe, Co, Ni, Cu, or the like. Specific examples thereof include lithium-cobalt composite oxides such as LiCoO₂, lithium-nickel composite oxides such as LiNiO₂, lithium-manganese composite oxides such as LiMnO₂, LiMn₂O₄, and Li₂MnO₄, and those obtained by substituting the transition metal atoms as main components of these lithium transition metal composite oxides with another element such as Na, K, B, F, Al, Ti, V, Cr, Mn, Fe, Co, Li, Ni, Cu, Zn, Mg, Ga, Zr, Si, Nb, Mo, Sn, or W. Specific examples of such materials include, but are not limited to, LiNi_{0.5}Mn_{0.5}O₂, LiNi_{0.85}Co_{0.10}Al_{0.05}O₂, LiNi_{0.5}Co_{0.2}Mn_{0.3}O₂, LiNi_{0.6}Co_{0.2}Mn_{0.2}O₂, LiNi_{0.33}Co_{0.33}Mn_{0.33}O₂, LiNi_{0.8}Co_{0.1}Mn_{0.1}O₂, LiNi_{0.45}Co_{0.10}Al_{0.45}O₂, LiMn_{1.8}Al_{0.2}O₄, and LiMn_{1.5}Ni_{0.5}O₄.

Particularly suitable lithium-containing transition metal composite oxide include LiMn_{1.5}Ni_{0.5}O₄, LiNi_{0.5}Co_{0.2}Mn_{0.3}O₂, and LiNi_{0.6}Co_{0.2}Mn_{0.2}O₂ each of which has a high energy density even at high voltage. In the case of a high voltage of 4.4 V or higher, LiMn_{1.5}Ni_{0.5}O₄ is preferred. In order to provide a high-capacity lithium ion secondary battery, the lithium-containing transition metal composite oxides of LiNi_{0.6}Co_{0.2}Mn_{0.2}O₂, LiNi_{0.8}Co_{0.1}Mn_{0.1}O₂, and LiNi_{0.85}Co_{0.10}Al_{0.05}O₂ are particularly suitable.

The transition metal of the lithium-containing transition metal phosphoric acid compound can be chosen from V, Ti, Cr, Mn, Fe, Co, Ni, Cu, or the like. Specific examples thereof include iron phosphates such as LiFePO₄, Li₃Fe₂(PO₄)₃, and LiFeP₂O₇, cobalt phosphates such as LiCoPO₄, and those obtained by substituting some of the transition metal atoms as the main components of these lithium transition metal phosphoric acid compounds with another element such as Al, Ti, V, Cr, Mn, Fe, Co, Li, Ni, Cu, Zn, Mg, Ga, Zr, Nb, or Si.

Examples of the lithium-containing transition metal composite oxide include lithium-manganese spinel composite oxides represented by the formula: LiₐMn_{2-b}M¹_{b}O₄ (wherein 0.9≤a; 0≤b≤1.5; and M¹ is at least one metal selected from the group consisting of Fe, Co, Ni, Cu, Zn, Al, Sn, Cr, V, Ti, Mg, Ca, Sr, B, Ga, In, Si, and Ge), lithium-nickel composite oxides represented by the formula: LiNi_{1-c}M²_{c}O₂ (wherein 0≤c≤0.5; and M² is at least one metal selected from the group consisting of Fe, Co, Mn, Cu, Zn, Al, Sn, Cr, V, Ti, Mg, Ca, Sr, B, Ga, In, Si, and Ge), and lithium-cobalt composite oxides represented by the formula: LiCo₁₋ₐM³_{d}O₂ (wherein 0≤d≤0.5; and M³ is at least one metal selected from the group consisting of Fe, Ni, Mn, Cu, Zn, Al, Sn, Cr, V, Ti, Mg, Ca, Sr, B, Ga, In, Si, and Ge).

In order to provide a high-power lithium ion secondary battery having a high energy density, exemplary positive electrode active materials include LiCoO₂, LiMnO₂, LiNiO₂, LiMn₂O₄, LiNi_{0.8}Co_{0.15}Al_{0.05}O₂, or LiNi_{1/3}Co_{1/3}Mn_{1/3}O₂.

Other examples of the positive electrode active material include LiFePO₄, LiNi_{0.8}Co_{0.2}O₂, Li_{1.2}Fe_{0.4}Mn_{0.4}O₂, LiNi_{0.5}Mn_{0.5}O₂, LiV₃O₆, and Li₂MnO₃.

Examples of the sulfur-based materials include materials containing a sulfur atom, such as, for example elemental sulfur, metal sulfides, and organosulfur compounds. The metal sulfides may be metal polysulfides. The organosulfur compounds may be organic polysulfides.

Examples of metal sulfides include compounds represented by LiSₓ (0<x≤8), compounds represented by Li₂Sₓ (0<x≤8), compounds having a 2D lamellar structure such as TiS₂ and MoS₂, and chevrel compounds having a strong 3D skeletal structure such as those represented by the formula: MeₓMo₆S₈ (wherein Me is a transition metal such as Pb, Ag, or Cu).

Examples of the organosulfur compounds include carbon sulfide compounds.

The organosulfur compounds each may be supported on a material having pores, such as carbon, and thereby used as a carbon composite material. In order to give much better cycle performance and further reduce the overvoltage, the amount of sulfur contained in the carbon composite material is from 10 to 99% by mass, 20% by mass or more, 30% by mass or more, 40% by mass or more, and in embodiments 85% by mass or less, relative to the mass of the carbon composite material.

In the case where the positive electrode active material is elemental sulfur, the amount of sulfur contained in the positive electrode active material is equal to the amount of the elemental sulfur contained.

Examples of the conductive polymers include p-doped conductive polymers and n-doped conductive polymers. Examples of the conductive polymers include polyacetylene-based polymers, polyphenylene-based polymers, heterocyclic polymers, ionic polymers, ladder-shaped polymers, and network polymers.

In order to improve the continuous charge characteristics, the positive electrode active material may contain lithium phosphate. Lithium phosphate may be used in any manner, and can be used in admixture with the positive electrode active material. The lower limit of the amount of lithium phosphate used is typically 0.1% by mass or more, 0.3% by mass or more, or 0.5% by mass or more, relative to the sum of the amounts of the positive electrode active material and lithium phosphate. While the upper limit thereof is typically 10% by mass or less, 8% by mass or less, or 5% by mass or less.

To a surface of the positive electrode active material may be attached a substance having a composition different from the positive electrode active material. Examples of the substance attached to the surface include oxides such as aluminum oxide, silicon oxide, titanium oxide, zirconium oxide, magnesium oxide, calcium oxide, boron oxide, antimony oxide, and bismuth oxide; sulfates such as lithium sulfate, sodium sulfate, potassium sulfate, magnesium sulfate, calcium sulfate, and aluminum sulfate; carbonates such as lithium carbonate, calcium carbonate, and magnesium carbonate; and carbon.

Such a substance may be attached to a surface of the positive electrode active material by, for example, a method of dissolving or suspending the substance in a solvent, impregnating the solution or suspension into the positive electrode active material, and drying the impregnated material; a method of dissolving or suspending a precursor of the substance in a solvent, impregnating the solution or suspension into the positive electrode active material, and heating the material and the precursor to cause a reaction therebetween; or a method of adding the substance to a precursor of the positive electrode active material and simultaneously sintering the materials. In the case of attaching carbon, for example, a carbonaceous material in the form of activated carbon may be mechanically attached to the surface afterward.

The mass of the substance attached to the surface relative to the amount of the positive electrode active material, is typically 0.1 ppm or more, 1 ppm or more, or 10 ppm or more, while the upper limit is typically 20% or less, 10% or less, or 5% or less. The substance attached to the surface can reduce oxidation of the electrolyte solution on the surface of the positive electrode active material, improving the battery life. Too small an amount of the substance may fail to sufficiently provide this effect. Too large an amount thereof may hinder the entrance and exit of lithium ions, increasing the resistance.

Particles of the positive electrode active material may have any shape conventionally used, such as a bulky shape, a polyhedral shape, a spherical shape, an ellipsoidal shape, a plate shape, a needle shape, or a pillar shape. The primary particles may agglomerate to form secondary particles.

The positive electrode active material may have a tap density of usually 1.5 g/cm³ or higher, 2.0 g/cm³ or higher, 2.5 g/cm³ or higher, or 3.0 g/cm³ or higher. A positive electrode active material having a tap density below the lower limit may cause an increased amount of a dispersion medium required and increased amounts of a conductive material and a binder required in formation of the positive electrode active material layer, as well as limitation on the packing fraction of the positive electrode active material in the positive electrode active material layer, resulting in limitation on the battery capacity. A metal composite oxide powder having a high tap density enables formation of a positive electrode active material layer with a high density. The tap density is usually preferably as high as possible and has no upper limit.

In the disclosure, the tap density is determined as a powder packing density (tap density) g/cm³ when 5 to 10 g of the positive electrode active material powder is packed into a 10-ml glass graduated cylinder and the cylinder is tapped 200 times with a stroke of about 20 mm.

The particles of the positive electrode active material may have a median size d50 (or a secondary particle size when the primary particles agglomerate to form secondary particles) of 0.3 μm or greater, 0.5 μm or greater, 0.8 μm or greater, or 1.0 μm or greater, within an upper limit of 30 μm or smaller, 27 μm or smaller, 25 μm or smaller, or 22 μm or smaller. The particles having a median size below the lower limit may fail to provide a product with a high tap density. The particles having a median size greater than the upper limit may cause prolonged diffusion of lithium in the particles, impairing the battery performance and generating streaks in formation of the positive electrode for a battery, i.e., when the active material and components such as a conductive material and additive are formed into slurry by adding a solvent and the slurry is applied in the form of a film, for example. Mixing two or more positive electrode active materials having different median sizes d50 can further improve the easiness of packing in formation of the positive electrode.

In the disclosure, the median size d50 is determined using a known laser diffraction/scattering particle size distribution analyzer. In the case of using LA-920 (Horiba, Ltd.) as the particle size distribution analyzer, the dispersion medium used in the measurement is a 0.1% by mass sodium hexametaphosphate aqueous solution and the measurement refractive index is set to 1.24 after 5-minute ultrasonic dispersion.

When the primary particles agglomerate to form secondary particles, the average primary particle size of the positive electrode active material may be 0.05 μm or greater, 0.1 μm or greater, or 0.2 μm or greater. The upper limit of such a agglomerates may be 5 μm or smaller, 4 μm or smaller, 3 μm or smaller, or 2 μm or smaller. The primary particles having an average primary particle size greater than the upper limit may have difficulty in forming spherical secondary particles, adversely affecting the powder packing. Further, such primary particles may have a greatly reduced specific surface area, highly possibly impairing the battery performance such as output characteristics. In contrast, the primary particles having an average primary particle size below the lower limit may usually be insufficiently grown crystals, causing poor charge and discharge reversibility, for example.

In the disclosure, the primary particle size is measured by scanning electron microscopic (SEM) observation. Specifically, the primary particle size is determined as follows. A photograph at a magnification of 10000× is first taken. Any 50 primary particles are selected and the maximum length between the left and right boundary lines of each primary particle is measured along the horizontal line. Then, the average value of the maximum lengths is calculated, which is defined as the primary particle size.

The positive electrode active material may have a BET specific surface area of preferably 0.1 m²/g or larger, 0.2 m²/g or larger, or 0.3 m²/g or larger. The upper limit may be 50 m²/g or smaller, 40 m²/g or smaller, or 30 m²/g or smaller. The positive electrode active material having a BET specific surface area smaller than the above range may easily impair the battery performance. The positive electrode active material having a BET specific surface area larger than the above range may less easily have an increased tap density, easily causing a difficulty in applying the material in formation of the positive electrode active material layer.

In the disclosure, the BET specific surface area is defined by a value determined by single point BET nitrogen adsorption utilizing a gas flow method using a surface area analyzer (e.g., fully automatic surface area measurement device, Ohkura Riken Co., Ltd.), a sample pre-dried in nitrogen stream at 150° C. for 30 minutes, and a nitrogen-helium gas mixture with the nitrogen pressure relative to the atmospheric pressure being accurately adjusted to 0.3.

When the lithium ion secondary battery of the disclosure is used as a large-size lithium ion secondary battery for hybrid vehicles or distributed generation, it needs to achieve high output. Thus, the particles of the positive electrode active material preferably mainly composed of secondary particles.

The particles of the positive electrode active material may include 0.5 to 7.0% by volume of fine particles having an average secondary particle size of 40 μm or smaller and having an average primary particle size of 1 μm or smaller. The presence of fine particles having an average primary particle size of 1 μm or smaller enlarges the contact area with the electrolyte solution and enables more rapid diffusion of lithium ions between the electrode and the electrolyte solution, improving the output performance of the battery.

The positive electrode active material may be produced by any usual method of producing an inorganic compound. In particular, a spherical or ellipsoidal active material can be produced by various methods. For example, a material substance of transition metal is dissolved or crushed and dispersed in a solvent such as water, and the pH of the solution or dispersion is adjusted under stirring to form a spherical precursor. The precursor is recovered and, if necessary, dried. Then, a Li source, such as LiOH, Li₂CO₃, or LiNO₃ is added thereto and the mixture is sintered at high temperature, thereby providing an active material.

In production of the positive electrode, one of the aforementioned positive electrode active materials may be used alone, or two or more materials having different compositions may be used in any combination at any ratio. Non-limiting examples of a combination of LiCoO₂ and LiMn₂O₄ in which part of Mn may optionally be replaced by a different transition metal (e.g., LiNi_{0.33}Co_{0.33}Mn_{0.33}O₂), and a combination with LiCoO₂ in which part of Co may optionally be replaced by a different transition metal.

In order to achieve a high battery capacity, the amount of the positive electrode active material is preferably 50 to 99.5% by mass, or 80 to 99% by mass, of the positive electrode mixture. The amount of the positive electrode active material in the positive electrode active material layer may be 80% by mass or more, 82% by mass or more, or 84% by mass or more, and the upper limit may be 99% by mass or less, or 98% by mass or less. Too small an amount of the positive electrode active material in the positive electrode active material layer may cause an insufficient electric capacity. In contrast, too large an amount thereof may cause insufficient strength of the positive electrode.

The negative electrode includes a negative electrode active material layer containing a negative electrode active material and a current collector.

The negative electrode material may be any one that can electrochemically occlude and release lithium ions. Specific examples thereof include carbon materials, alloyed materials, lithium-containing metal composite oxide materials, and conductive polymers. One of these may be used alone or two or more thereof may be used in any combination.

Examples of the negative electrode active material include carbonaceous materials that can occlude and release lithium such as pyrolysates of organic matter under various pyrolysis conditions, artificial graphite, and natural graphite; metal oxide materials that can occlude and release lithium such as tin oxide and silicon oxide; lithium metals; various lithium alloys; and lithium-containing metal composite oxide materials. Two or more of these negative electrode active materials may be used in admixture with each other.

The carbonaceous material that can occlude and release lithium is preferably artificial graphite produced by high-temperature treatment of easily graphitizable pitch from various materials, purified natural graphite, or a material obtained by surface treatment on such graphite with pitch or other organic matter and then carbonization of the surface-treated graphite. In order to achieve a good balance between the initial irreversible capacity and the high-current-density charge and discharge characteristics, the carbonaceous material is more preferably selected from carbonaceous materials obtained by heat-treating natural graphite, artificial graphite, artificial carbonaceous substances, or artificial graphite substances at 400° C. to 3200° C. once or more; carbonaceous materials which allow the negative electrode active material layer to include at least two or more carbonaceous matters having different crystallinities and/or have an interface between the carbonaceous matters having the different crystallinities; and carbonaceous materials which allow the negative electrode active material layer to have an interface between at least two or more carbonaceous matters having different orientations. One of these carbonaceous materials may be used alone or two or more thereof may be used in any combination at any ratio.

Examples of the carbonaceous materials obtained by heat-treating artificial carbonaceous substances or artificial graphite substances at 400° C. to 3200° C. once or more include coal-based coke, petroleum-based coke, coal-based pitch, petroleum-based pitch, and those prepared by oxidizing these pitches; needle coke, pitch coke, and carbon materials prepared by partially graphitizing these cokes; pyrolysates of organic matter such as furnace black, acetylene black, and pitch-based carbon fibers; carbonizable organic matter and carbides thereof; and solutions prepared by dissolving carbonizable organic matter in a low-molecular-weight organic solvent such as benzene, toluene, xylene, quinoline, or n-hexane, and carbides thereof.

The metal material (excluding lithium-titanium composite oxides) to be used as the negative electrode active material may be any compound that can occlude and release lithium, and examples thereof include simple lithium, simple metals and alloys that constitute lithium alloys, and oxides, carbides, nitrides, silicides, sulfides, and phosphides thereof. The simple metals and alloys constituting lithium alloys are preferably materials containing any of metal and semi-metal elements in Groups 13 and 14, more preferably simple metal of aluminum, silicon, and tin (hereinafter, referred to as “specific metal elements”), and alloys and compounds containing any of these atoms. One of these materials may be used alone or two or more thereof may be used in combination at any ratio.

Examples of the negative electrode active material containing at least one atom selected from the specific metal elements include simple metal of any one specific metal element, alloys of two or more specific metal elements, alloys of one or two or more specific metal elements and one or two or more other metal elements, compounds containing one or two or more specific metal elements, and composite compounds such as oxides, carbides, nitrides, silicides, sulfides, and phosphides of the compounds. Such a simple metal, alloy, or metal compound used as the negative electrode active material can lead to a high-capacity battery.

Further examples include compounds in which any of the above composite compounds are complexly bonded with several elements such as simple metals, alloys, and nonmetal elements. Specifically, in the case of silicon or tin, for example, an alloy of this element and a metal that does not serve as a negative electrode may be used. In the case of tin, for example, a composite compound including a combination of 5 or 6 elements, including tin, a metal (excluding silicon) that serves as a negative electrode, a metal that does not serve as a negative electrode, and a nonmetal element, may be used.

Specific examples for the negative electrode active material include simple Si, SiB₄, SiB₆, Mg₂Si, Ni₂Si, TiSi₂, MoSi₂, CoSi₂, NiSi₂, CaSi₂, CrSi₂, Cu₆Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, simple tin, SnSiO₃, LiSnO, Mg₂Sn, and SnO_{w} (0<w≤2). Examples thereof further include composite materials of Si or Sn used as a first component, and second and third components. The second component is at least one selected from the group consisting of cobalt, iron, magnesium, titanium, vanadium, chromium, manganese, nickel, copper, zinc, gallium, and zirconium, for example. The third component is at least one selected from the group consisting of boron, carbon, aluminum, and phosphorus, for example.

In order to achieve a high battery capacity and excellent battery characteristics, the metal material is preferably simple silicon or tin (which may contain trace impurities), SiOᵥ (0<v≤2), SnO_{w} (0≤w≤2), a Si—Co—C composite material, a Si—Ni—C composite material, a Sn—Co—C composite material, or a Sn—Ni—C composite material.

The lithium-containing metal composite oxide material to be used as the negative electrode active material may be any material that can occlude and release lithium. In order to achieve good high-current-density charge and discharge characteristics, materials containing titanium and lithium are preferred, lithium-containing metal composite oxide materials containing titanium are more preferred, and composite oxides of lithium and titanium (hereinafter, abbreviated as “lithium titanium composite oxides”) are still more preferred. In other words, use of a spinel-structured lithium titanium composite oxide in the negative electrode active material for an electrolyte battery is particularly preferred because this can markedly reduce the output resistance.

Examples of the lithium titanium composite oxides include compounds represented by the following formula:

LiₓTi_{y}M_{z}O₄

wherein M is at least one element selected from the group consisting of Na, K, Co, Al, Fe, Ti, Mg, Cr, Ga, Cu, Zn, and Nb.

In order to achieve a good balance of the battery performance, particularly suitable among the above compositions are those satisfying any of the following conditions:
(i) 1.2≤x≤1.4, 1.5≤y≤1.7, z=0
(ii) 0.9≤x≤1.1, 1.9≤y≤2.1, z=0
(iii) 0.7 5×≤0.9, 2.1≤y≤2.3, z=0.

Particularly suitable compositions of the compound are Li_{4/3} Ti_{5/3}O₄ corresponding to the composition (i), Li₁Ti₂O₄ corresponding to the composition (ii), and Li_{4/5}Ti_{11/5}O₄ corresponding to the composition (iii). An example of a structure satisfying Z≠0 include Li_{4/3}Ti_{4/3}Al_{1/3}O₄.

The battery may employ an electrolyte solution. The electrolyte solution is not particularly limited and can be selected as desired for a particular application or intended use. The electrolyte solution may comprise an electrolyte salt and a solvent. For lithium batteries, the electrolyte salt is selected from a lithium salt. Examples of lithium salts include, but are not limited to, inorganic lithium salts such as LiPF₆, LiBF₄, LiClO₄, LiAlF₄, LiSbF₆, LiTaF₆, LiWF₇, LiAsF₆, LiAlCl₄, LiI, LiBr, LiCl, LiB₁₀Cl₁₀, Li₂SiF₆, Li₂PFO₃, and LiPO₂F₂; lithium tungstates such as LiWOF₅; lithium carboxylates such as HCO₂Li, CH₃CO₂Li, CH₂FCO₂Li, CHF₂CO₂Li, CF₃CO₂Li, CF₃CH₂CO₂Li, CF₃CF₂CO₂Li, CF₃CF₂CF₂CO₂Li, and CF₃CF₂CF₂CF₂CO₂Li; lithium salts containing an S—O group such as FSO₃Li, CH₃SO₃Li, CH₂FSO₃Li, CHF₂SO₃Li, CF₃SO₃Li, CF₃CF₂SO₃Li, CF₃CF₂CF₂SO₃Li, CF₃CF₂CF₂CF₂SO₃Li, lithium methylsulfate, lithium ethylsulfate (C₂H₅OSO₃Li), and lithium 2,2,2-trifluoroethylsulfate; lithium imide salts such as LiN(FCO)₂, LiN(FCO)(FSO₂), LiN(FSO₂)₂, LiN(FSO₂)(CF₃SO₂), LiN(CF₃SO₂)₂, LiN(C₂F₅SO₂)₂, lithium bis-perfluoroethanesulfonyl imide, lithium cyclic 1,2-perfluoroethanedisulfonyl imide, lithium cyclic 1,3-perfluoropropanedisulfonyl imide, lithium cyclic 1,2-ethanedisulfonyl imide, lithium cyclic 1,3-propanedisulfonyl imide, lithium cyclic 1,4-perfluorobutanedisulfonyl imide, LiN(CF₃SO₂)(FSO₂), LiN(CF₃SO₂)(C₃F₇SO₂), LiN(CF₃SO₂)(C₄F₉SO₂), and LiN(POF₂)₂; lithium methide salts such as LiC(FSO₂)₃, LiC(CF₃SO₂)₃, and LiC(C₂F₅SO₂)₃; and fluorine-containing organic lithium salts such as salts represented by the formula: LiPFₐ(CₙF₂ₙ₊₁)₆₋ₐ (wherein a is an integer of 0 to 5; and n is an integer of 1 to 6) such as LiPF₃(C₂F₅)₃, LiPF₃(CF₃)₃, LiPF₃(iso-C₃F₇)₃, LiPF₅(iso-C₃F₇), LiPF₄(CF₃)₂, and LiPF₄(C₂F₅)₂, as well as LiPF₄(CF₃SO₂)₂, LiPF₄(C₂F₅SO₂)₂, LiBF₃CF₃, LiBF₃C₃F₇, LiBF₃C₂F₅, LiBF₂(CF₃)₂, LiBF₂(C₂F₅)₂, LiBF₂(CF₃SO₂)₂, and LiBF₂(C₂F₅SO₂)₂, and LiSCN, LiB(CN)₄, LiB(C₆H₅)₄, Li₂(C₂O₄), LiP(C₂O₄)₃, and Li₂B₁₂F_{b}H_{12-b} (wherein b is an integer of 0 to 3).

The solvents can be any of a variety of non-aqueous, aprotic, and polar organic compounds. Generally, solvents may be carbonates, carboxylates, ethers, lactones, sulfones, phosphates, nitriles, and ionic liquids. Useful carbonate solvents herein include, but are not limited to: cyclic carbonates, such as propylene carbonate and butylene carbonate, and linear carbonates, such as dimethyl carbonate, diethyl carbonate, dipropyl carbonate, dibutyl carbonate, ethyl methyl carbonate, methyl propyl carbonate, and ethyl propyl carbonate.

Useful carboxylate solvents include, but are not limited to: methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, and butyl butyrate.

Useful ethers include, but are not limited to: tetrahydrofuran, 2-methyl tetrahydrofuran, 1,3-dioxolane, 1,4-dioxane, 1,2-dimethoxyethane, 1,2-diethoxyethane, 1,2-dibutoxyethane, methyl nonafluorobutyl ether, and ethyl nonafluorobutyl ether.

Useful lactones include, but are not limited to: γ-butyrolactone, 2-methyl-γ-butyrolactone, 3-methyl-γ-butyrolactone, 4-methyl-γ-butyrolactone, β-propiolactone, and δ-valerolactone.

Useful phosphates include, but are not limited to: trimethyl phosphate, triethyl phosphate, tris(2-chloroethyl) phosphate, tris(2,2,2-trifluoroethyl) phosphate, tripropyl phosphate, triisopropyl phosphate, tributyl phosphate, trihexyl phosphate, triphenyl phosphate, tritolyl phosphate, methyl ethylene phosphate, and ethyl ethylene phosphate.

Useful sulfones include, but are not limited to: non-fluorinated sulfones, such as dimethyl sulfone and ethyl methyl sulfone, partially fluorinated sulfones, such as methyl trifluoromethyl sulfone, ethyl trifluoromethyl sulfone, methyl pentafluoroethyl sulfone, and ethyl pentafluoroethyl sulfone, and fully fluorinated sulfones, such as di(trifluoromethyl) sulfone, di(pentafluoroethyl) sulfone, trifluoromethyl pentafluoroethyl sulfone, trifluoromethyl nonafluorobutyl sulfone, and pentafluoroethyl nonafluorobutyl sulfone.

Useful nitriles include, but are not limited to: acetonitrile, propionitrile, butyronitrile and dinitriles, CN[CH₂]ₙCN with various alkane chain lengths (n=1-8).

An ionic liquid (IL) is a salt in the liquid state. In some contexts, the term has been restricted to salts whose melting point is below some arbitrary temperature, such as 100° C. (212° F.). ILs are largely made of ions and short-lived ion pairs. Common anions of ILs are TFSi, FSi, BOB, PF₆₋ₓRₓ, BF₄, etc and cations of ILs are imidazolium, piperidinium, pyrrolidinium, tetraalkylammonium, morpholinium, etc. Useful ionic liquids include, but not limited to: Bis(oxalate)borate (BOB) anion based ionic liquids, such as N-cyanoethyl-N-methylprrrolidinium BOB, 1-methyl-1-(2-methylsulfoxy)ethyl)-pyrrolidinium BOB, and 1-methyl-1-((1,3,2-dioxathiolan-2-oxide-4-yl)methyl)pyrrolidinium BOB; tris(pentafluoroethyl)trifluorophosphate (FAP) anion based ionic liquids, such as N-allyl-N-methylpyrrrolidinium FAP, N-(oxiran-2-ylmethyl)N-methylpyrrolidinium FAP, and N-(prop-2-inyl)N-methylpyrrolidinium FAP; bis(trifluoromethanesulfonyl)imide (TFSI) anion-based ionic liquids, such as N-propyl-N-methylpyrrolidinium TFSI, 1,2-dimethyl-3-propylimidazolium TFSI, 1-octyl-3-methyl-imidazolium TFSI, and 1-butyl-methylpyrrolidinium TFSI; Bis(fluorosulfonyl)imide (FSI) anion-based ionic liquids, such as N-Butyl-N-methylmorpholinium FSI and N-propyl-N-methylpiperidinium FSI; and other ionic liquids such as 1-ethyl-3-methylimidazolium tetrafluoroborate.

Two or more of these solvents may be used in the electrolytic solution. Other solvents may be utilized as long as they are non-aqueous and aprotic, and are capable of dissolving the salts, such as N,N-dimethyl formamide, N,N-dimethyl acetamide, N,N-diethyl acetamide, and N,N-dimethyl trifluoroacetamide. Carbonates are preferred, with the most preferred being ethylene carbonate (EC), ethyl methyl carbonate (EMC) and mixtures thereof. The amount of solvent is between 70% to 95% of the total electrolyte weight, more preferably, the amount of salt is between 80% to 90% of the total electrolyte weight.

Examples of the electrochemical devices include lithium ion secondary batteries, lithium ion capacitors, capacitors such as hybrid capacitors and electric double-layer capacitors, radical batteries, solar cells, in particular dye-sensitized solar cells, lithium ion primary batteries, fuel cells, various electrochemical sensors, electrochromic elements, electrochemical switching elements, aluminum electrolytic capacitors, and tantalum electrolytic capacitors. Preferred are lithium ion secondary batteries, lithium ion capacitors, and electric double-layer capacitors. A module including the electrochemical device is also one aspect of the disclosure.

The lithium ion secondary battery may further include a separator. The separator may be formed from any known material and may have any known shape as long as the resulting separator is stable to the electrolyte solution and is excellent in a liquid-retaining ability. The separator is preferably in the form of a porous sheet or a nonwoven fabric which is formed from a material stable to the electrolyte solution of the disclosure, such as resin, glass fiber, or inorganic matter, and which has an excellent liquid-retaining ability.

Examples of the material of a resin or glass-fiber separator include polyolefins such as polyethylene and polypropylene, aromatic polyamide, polytetrafluoroethylene, polyether sulfone, and glass filters. One of these materials may be used alone or two or more thereof may be used in any combination at any ratio, for example, in the form of a polypropylene/polyethylene bilayer film or a polypropylene/polyethylene/polypropylene trilayer film. In order to achieve good permeability of the electrolyte solution and a good shut-down effect, the separator is preferably a porous sheet or a nonwoven fabric formed from a polyolefin such as polyethylene or polypropylene.

The separator may have any thickness, and the thickness is usually 1 μm or greater, 5 μm or greater, or 8 μm or greater, while usually 50 μm or smaller, 40 μm or smaller, or 30 μm or smaller. A separator thinner than the above range may have poor insulation and mechanical strength. The separator thicker than the above range may cause not only poor battery performance such as poor rate characteristics but also a low energy density of the whole electrolyte battery.

A separator which is porous such as a porous sheet or a nonwoven fabric may have any porosity. The porosity is usually 20% or higher, preferably 35% or higher, more preferably 45% or higher, while usually 90% or lower, preferably 85% or lower, more preferably 75% or lower. The separator having a porosity lower than the above range tends to have high film resistance, causing poor rate characteristics. The separator having a porosity higher than the above range tends to have low mechanical strength, causing poor insulation.

The separator may also have any average pore size. The average pore size is usually 0.5 μm or smaller, or 0.2 μm or smaller, while usually 0.05 μm or larger. The separator having an average pore size larger than the above range may easily cause short circuits. The separator having an average pore size smaller than the above range may have high film resistance, causing poor rate characteristics.

Examples of the inorganic matter include oxides such as alumina and silicon dioxide, nitrides such as aluminum nitride and silicon nitride, and sulfates such as barium sulfate and calcium sulfate, each in the form of particles or fibers.

The separator is in the form of a thin film such as a nonwoven fabric, a woven fabric, or a microporous film. The thin film favorably has a pore size of 0.01 to 1 μm and a thickness of 5 to 50 μm. Instead of the above separate thin film, the separator may have a structure in which a composite porous layer containing particles of the above inorganic matter is disposed on a surface of one or each of the positive and negative electrodes using a resin binder. For example, alumina particles having a 90% particle size of smaller than 1 μm may be applied to the respective surfaces of the positive electrode with fluororesin used as a binder to form a porous layer.

### <Battery Design>

The electrode group may be either a laminate structure including the above positive and negative electrode plates with the above separator in between, or a wound structure including the above positive and negative electrode plates in spiral with the above separator in between. The proportion of the volume of the electrode group in the battery internal volume (hereinafter, referred to as an electrode group proportion) is usually 40% or higher, or 50% or higher, while usually 90% or lower, or 80% or lower.

In an electrode group having the laminate structure, the metal core portions of the respective electrode layers are preferably bundled and welded to a terminal. If an electrode has a large area, the internal resistance is high. Thus, multiple terminals may preferably be disposed in the electrode so as to reduce the resistance. In an electrode group having the wound structure, multiple lead structures may be disposed on each of the positive electrode and the negative electrode and bundled to a terminal. This can reduce the internal resistance.

The external case may be made of any material that is stable to an electrolyte solution to be used. Specific examples thereof include metals such as nickel-plated steel plates, stainless steel, aluminum and aluminum alloys, and magnesium alloys, and a layered film (laminate film) of resin and aluminum foil. In order to reduce the weight, a metal such as aluminum or an aluminum alloy or a laminate film is favorably used.

An external case made of metal may have a sealed-up structure formed by welding the metal by laser welding, resistance welding, or ultrasonic welding, or a caulking structure using the metal with a resin gasket in between. An external case made of a laminate film may have a sealed-up structure formed by hot-melting resin layers. In order to improve the sealability, a resin which is different from the resin of the laminate film may be disposed between the resin layers. Especially, in the case of forming a sealed-up structure by hot-melting the resin layers with current collecting terminals in between, metal and resin are to be bonded. Thus, the resin to be disposed between the resin layers is favorably a resin having a polar group or a modified resin having a polar group introduced therein.

The lithium ion secondary battery of the disclosure may have any shape, such as a cylindrical shape, a square shape, a laminate shape, a coin shape, or a large-size shape. The shapes and the structures of the positive electrode, the negative electrode, and the separator may be changed in accordance with the shape of the battery.

### Examples

The electrode fabrication for a lithium-ion coin cell comprises the anode active materials and the composition of the present application. For the benchmark electrode composition, the composition comprises styrene butadiene rubber (SBR) and carboxymethyl cellulose (CMC). The ureidofunctional organosilicon material (also referred to herein in examples as UPY) was added to a SBR/CMC mixture for the test formulations. In all cases the slurry was developed by addition of required volume of water. The active materials for the slurry included graphite, silicon monoxide, and carbon black in the ratio of 80:14:1. The rest of the 5 wt % of the composite comprises the composition of the present application including the polymer, ureido functional organosilicon material, and electrode active agent. The benchmark electrode compositions comprising SBR and CMC in the ratio of 3:2 was identified as the suitable ratio providing a well-integrated coating on the current collector surface. In case of the test samples, the ureido functional organosilicon material was used along with SBR and CMC, in the ratio of SBR/CMC/ureido functional material=2:1:1 to achieve the coating on current collector. In the test sample of 100 gm, 1 gm of UPY was used (1 wt %) along with 2 gm of SBR (2 wt %) and 1 gm of CMC (1 w %) per total weight of the electrode composition.

The electrode slurry development was performed in a speed mixture, wherein, in the first step, the respective amounts of electrode active materials, graphite and carbon black along with silicon monoxide were mixed at 2000 rpm for a minute. This mixing was repeated thrice to achieve a homogeneous mixture. Subsequently, calculated amount of SBR was added and mixed again at 2000 rpm for three repetitions, when stickiness was observed to develop in the composite. Following to this CMC and calculated amount of additive was added and mixed in speed mixture at 2000 rpm for three repetitions. Finally required amount of water was added to achieve a thick slurry coatable on the electrode. The homogenous mixing of water was also ensured by speed mixing for three repetition at 2000 rpm.

The slurry was then coated on the surface of a current collector of 50 μm thickness using a wire coater. The coated foil was then dried in a vacuum oven for 6 hours at 110° C. and then coins were cut from the foil for assembling the 2032-coin cells.

For dry coating technology, required amounts of anode active material comprising graphite, silicon monoxide, and carbon black were initially mixed with binder comprising the nitrogen containing silane additive. The composition was mixed 120° C. for 4 hours. Subsequently, the mixture was passed through twin rollers at high temperature over current collector metal foil, which results in the formation of a coating on the current collector. Following the formation of the coating, the coins were cut from foil and assembled in coin cell as described further.

The lithium-ion cells are fabricated inside the argon filled glove box with lithium as the counter electrode, LiPF₆ (1M)/EC/EMC as the electrolyte, and a Celgard separator. The cells were analyzed on Biologic BCS 805 to determine the electrochemical characteristics.

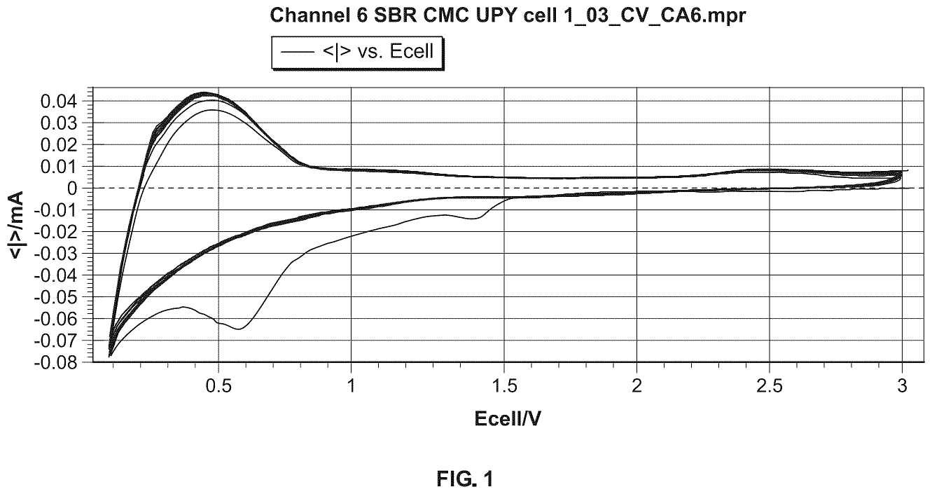

The electrochemical analysis of the ureidofunctional organosilicon material (UPY) to SBR/CMC formulation was performed in a 2032 lithium-ion coin cell. The working electrode comprised graphite/SiO/CB, wherein the carbon black (CB) is added as a conductivity reinforcement ingredient. As mentioned earlier, the coin cells were assembled inside the Argon filled glove box and neat lithium coins were used as the counter electrode. Initially the cyclic voltammogram (CV) was recorded between 3.0-0.1 V and ten cycles of charge/discharge were recorded. The first discharge curve shows the presence of troughs between 1.4-1.1 V suggesting the formation of SEI layer. A deep fall is also noted below 0.6 V, attributed to the intercalation of lithium ions in the interstitial sites of graphite and also along the edges. FIG. 1 shows a cyclic voltammogram of the graphite/SiO/CB electrode with the ureidofunctional organosilicon material (UPY) of formula:

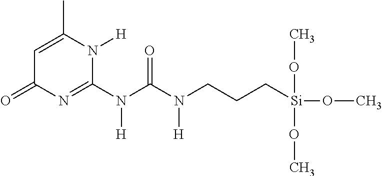 [SMILES: CO[Si](CCCNC(=O)Nc1nc(=O)cc(C)[nH]1)(OC)OC]

The corresponding charge cycle shows a hump at ˜0.5 V, attributed to the expunge of lithium ions from the graphite/SiO matrix. The subsequent cycles of charge/discharge show high reproducibility indicating that the electrode is highly stable, indicating the mechanical integrity of the electrode. The high stability with an electrode having a high expansion material can be attributed to efficient binder formulation which helps in retaining the mechanical integrity of the electrode. During the second and subsequent discharge cycles, there is no presence of any troughs, suggesting that SEI formation was limited to the first discharge cycle.

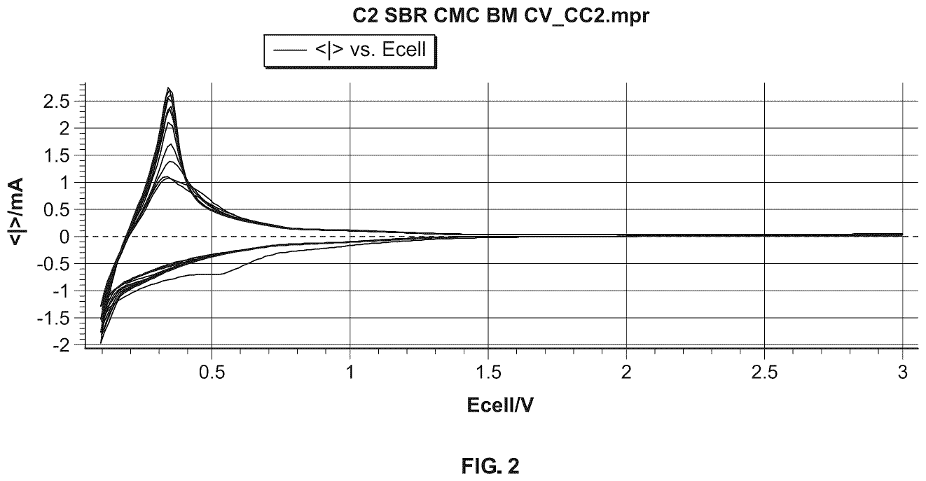

Also, the CV of the benchmark cell was performed and was noted to be as below. Though the fingerprint region of the peaks appeared in the similar voltage regions, indicating similar electrochemical activity, the CV curves in the benchmark binder were noted to demonstrate low current density. Also, instability in the charging cycles was noted, which indicate inferior performance of the benchmark binder. The effect of the presence of additive would be associated with the long-term cycling stability and capacity retention of the electrodes. FIG. 2 shows a cyclic voltammogram of a cell with a graphite/SiO/CB electrode with a SBR/CMC binder without the additive.

The cycling stability was performed at 50 mA/g current rate for 500 cycles and the calculated specific capacities are mentioned in Table 2.

TABLE 1
Specific capacity retention over 5000 cycles.

| | Inventive Composition | | Benchmark | |
|---|---|---|---|---|
| | Specific | | Specific | |
| | capacity | % capacity | capacity | % capacity |
| Cycle | (mAh/g) | retention vs | (mAh/g) | retention vs |
| number | (SBR/CMC/UPY) | initial cycle | (SBR/CMC) | initial cycle |
| Cycle 1 | 699 | — | 687 | — |
| Cycle 10 | 679 | 97 | 282 | 41 |
| Cycle 100 | 563 | 80 | 222 | 33 |
| Cycle 300 | 546 | 79 | 124 | 18 |
| Cycle 500 | 535 | 77 | 68 | ~10 |

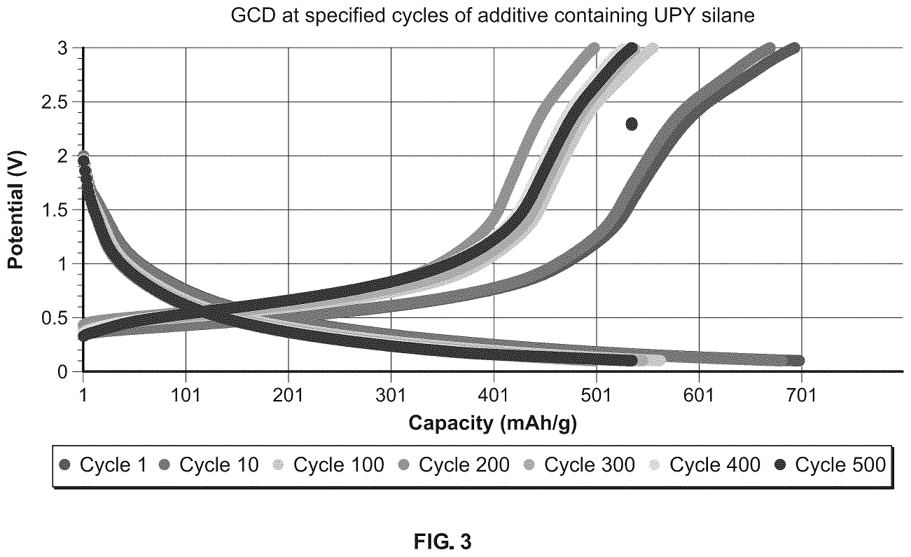

The capacity at different cycles were calculated and tabulated as in Table 1. It was noted that at the end of 500 cycles, the capacity of the inventive electrode composition (Column 2) was no retained at 77% (Column 3, row 6) versus the initial capacity. A In comparison, the benchmark composition (Column 4 of table 1) was able to demonstrate only 10% capacity retention after 500 cycles compared to its initial capacity. FIG. 3 shows the charge/discharge curves for various cycles numbers.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a binder material for use in an electrochemical device and applications thereof. Modifications may occur to those skilled in the art and to those who may make and use the invention. The disclosed embodiments are merely for illustrative purposes and not intended to limit the scope of the invention or the subject matter set forth in the claims.

What is claimed is:

1. A composition comprising:
(a) a polymeric resin;
(b) a compound represented by formula (I) 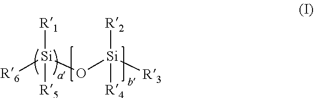
where R¹′, R²′, R³′, R⁴′, R⁵′, and R⁶′ is independently selected from the group consisting of R⁴, OR⁵, and a ureido functional group, where R⁴ is independently selected from a monovalent group selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms; R⁵ is independently selected from a monovalent group selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, an aralkyl having 7 to 20 carbon atoms;
a′ or b′ is 0-500 with the proviso that at least one of these a′ or b′ is >0; and at least one R¹′, R²′, R³′, R⁴′, R⁵′, and/or R⁶′ is a ureido functional group;
wherein the ureido functional group is represented by the formula: 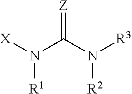
where R¹ and R² are each independently selected from the group consisting of hydrogen and a monovalent organic group having 1 to 20 carbon atoms;
R³ is a divalent straight chain alkylene group having 1 to 20 carbon atoms, or a divalent branched alkylene group having 3 to 20 carbon atoms, each of which optionally contains one or more heteroatoms within the chain; X is selected from the group consisting of a substituted or unsubstituted aromatic group having 6 to 20 carbon atoms and a heterocyclic group containing 1 to 20 heteroatoms, wherein the aromatic group and/or the heterocyclic group are optionally substituted with an alkyl group having from 1 to 12 carbon atoms optionally containing a heteroatom selected from the group consisting of O, N, and/or S and a ureido functional group:
and wherein Z is oxygen;
(c) an electrode active agent; and
(d) optionally a binding agent.

2. The composition of claim 1, wherein the polymeric resin is selected from one or more of a group consisting of polyethylene, polypropylene, polyethylene terephthalate, polymethyl methacrylate, aromatic polyamide, chitosan, alginic acid, polyacrylic acid, polyimide, cellulose, carboxy methyl cellulose, nitro cellulose; Styrene-butadiene rubber (SBR), isoprene rubber, butadiene rubber, fluoroelastomers, acrylonitrile-butadiene rubber (NBR), ethylene-propylene rubber; styrene-butadiene-styrene block copolymers and hydrogenated products thereof; EPDM (ethylene-propylene-diene terpolymers), styrene-ethylene-butadiene-styrene copolymers, styrene-isoprene-styrene block copolymers and hydrogenated products thereof; syndiotactic-1,2-polybutadiene, polyvinyl acetate, ethylene-vinyl acetate copolymers, and propylene-α-olefin copolymers; polyvinylidene fluoride, polytetrafluoroethylene, vinylidene fluoride copolymer, and tetrafluoroethylene-ethylene copolymers; and polymer containing alkali metal ions.

3. The composition of claim 1, wherein the optional binding agent is selected from one or more of a group consisting of carboxymethyl cellulose, methyl cellulose, hydroxymethyl cellulose, ethyl cellulose, polyvinyl alcohol, oxidized starch, monostarch phosphate, casein, polyvinylpyrrolidone, salts thereof.

4. The composition of claim 1, wherein the electrode active agent is selected from the group consisting of one or more of an intercalating agent and a conductive agent.

5. The composition of claim 4, wherein the intercalating agent is selected from the group consisting of graphite, lithium nickel manganese cobalt oxide (LiNMC), Si, SiB₄, SiB₆, Mg₂Si, Ni₂Si, TiSi₂, MoSi₂, CoSi₂, NiSi₂, CaSi₂, CrSi₂, Cu₆Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, Sn, SnSiO₃, LiSnO, and Mg₂Sn, SnO_{w} (0<w≤2).

6. The composition of claim 4, wherein the conductive agent is a carbonaceous conductive agent selected from the group consisting of graphite, including natural graphite, artificial graphite, carbon black, including acetylene black, Ketjen black, channel black, furnace black, lamp black, thermal black, amorphous carbon, including needle coke, carbon nanotube, fullerene, and vapor-phase grown carbon fibers (VGCF).

7. The composition of claim 1, wherein the a′>0 with the proviso that b′=0, and the compound represented by the formula (I) is a polysilane.

8. The composition of claim 7, wherein the compound of formula (I) has the formula: 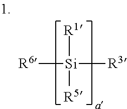
where R¹′, R³′, R⁵′, and R⁶′ are each independently selected from R⁴, OR⁵, and a ureido functional group, where R⁴ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
R⁵ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, and an aralkyl having 7 to 20 carbon atoms;
a′ is 1-500; and
at least one of R¹′, R³′, R⁵′, and R⁶′ is selected from a ureido functional group.

9. The composition of claim 1, wherein b′>0 with the proviso that a′=0, and the compound represented by the formula 1 is a polysiloxane.

10. The composition of claim 1, wherein the compound represented by the formula 1 is a ureido functional organosilicon.

11. The composition of claim 1, wherein the ureido functional organosilicon is a compound of the formula: 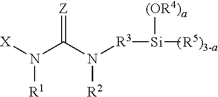
where,
R¹ and R² are each independently hydrogen or a monovalent organic group having 1 to 20 carbon atoms;
R³ is a divalent straight chain alkylene group having 1 to 20 carbon atoms, or a divalent branched alkylene group having 3 to 20 carbon atoms, each of which optionally contains one or more heteroatoms within the chain;
R⁴ is independently a monovalent group selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
R⁵ is independently selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
X is an aromatic group having 6 to 20 carbon atoms or a heterocyclic group containing up to 20 heteroatoms, wherein the aromatic group or the heterocyclic group is optionally substituted with an alkyl group having from 1 to 12 carbon atoms optionally containing a heteroatom selected from the group consisting of O, N, and/or S, and a ureido functional group:
Z is oxygen; and
a is an integer having the value 1, 2, or 3.

12. The composition of claim 1, wherein the compound of formula (I) is a polysiloxane represented by the formula:
M¹ₐM²_{b}D¹_{c}D²_{d}T¹ₑT²_{f}Q_{g}
where:
M¹ is (R¹⁶)(R¹⁷)(R¹⁸)SiO_{1/2}
M² is (R¹⁹)(R²⁰)(R²¹)SiO_{1/2}
D¹ is (R²²)(R²³)SiO_{2/2}
D² is (R²⁴)(R²⁵)SiO_{2/2}
T¹ is (R²⁶)SiO_{3/2}
T² is (R²⁷)SiO_{3/2}
Q is SiO_{4/2}
R¹⁶, R¹⁷, R¹⁸, R²², R²³, and R²⁶ are independently selected from the group consisting of R⁴ and OR⁵;
R¹⁹, R²⁰, R²¹, R²⁴, R²⁵, and R²⁷ are independently selected from the group consisting of R⁴, OR⁵ and a ureido functional group, with the proviso that at least one of R¹⁹, R²⁰, R²¹, R²⁴, R²⁵, and R²⁷ is a ureido functional group;
where R⁴ is independently selected from the group consisting of a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
R⁵ is independently selected from the group consisting of a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
b, d, and f are independently an integer greater than 0; and
a, c, e, and g are each independently an integer greater than 0.

13. The composition of claim 1, wherein X is a six membered ring comprising up to 5 nitrogen atoms.

14. The composition of claim 1, wherein X is a six membered ring comprising 1 or 2 nitrogen atoms.

15. The composition of claim 1, wherein X is selected from 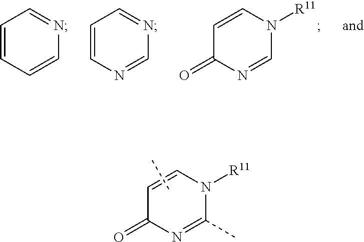
where R¹¹ is selected from the group consisting of hydrogen and a monovalent organic group having 1 to 12 carbon atoms.

16. The composition of claim 1, wherein X is 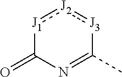
where J₁, J₂, and J₃ are each independently a substituted or unsubstituted C or N atom, the dashed lines between J₁, J₂, and J₃ indicate an optional double bond between J₁ and J₂ or J₂ and J₃.

17. The composition of claim 1, wherein the substituent in X is represented by the formula: 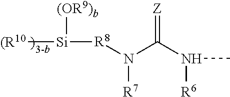
where R⁶ and R⁷ are each independently hydrogen or a monovalent organic group having 1 to 20 carbon atoms;
R⁸ is a divalent straight chain alkylene group having 1 to 20 carbon atoms, or a divalent branched alkylene group having 3 to 20 carbon atoms, each of which can optionally contain one or more heteroatoms within the chain;
R⁹ is each independently selected from the group consisting of a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms;
R¹⁰ is independently selected from a monovalent group selected from a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, and an aralkyl having 7 to 20 carbon atoms; and wherein b is an integer having a value 1, 2, or 3.

18. The composition of claim 17, wherein the ureidofunctional organosilicon is represented by the formula:

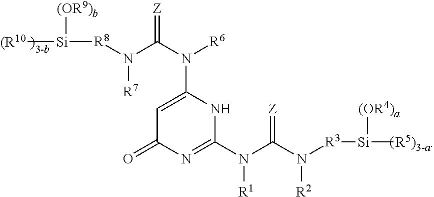

19. The composition of claim 1, wherein the compound represented by the formula 1 is present in an amount of about 0.1 to 10 wt. % based on the total weight of the composition.

20. The composition of claim 1, wherein the compound of the formula 1 is present in an amount of from about 0.01 wt. % to about 90 wt. %, from about 0.05 wt. % to about 80 wt. %, from about 0.1 wt. % to about 75 wt. %, from about 0.2 wt % to about 60 wt. %, from about 0.5 wt. % to about 50 wt. %, from about 1 wt. % to about 25 wt. %, or from about 5 wt. % to about 10 wt. % based on the total weight of the composition; preferably 1-10 wt %, 10-50 wt % or 50-90 wt %, based on the total weight of the composition.

21. The composition of claim 1, wherein the composition is a solventless composition.

22. An energy storage device comprising:
(a) at least one electrode; and
(b) an electrolyte, wherein the at least one electrode comprises the composition of claim 1.

23. The energy storage device of claim 22, wherein the device has a specific capacity as determined by cycling stability study, after at least 500 electrochemical cycles, of at least 20% of its specific capacity after the first cycle.

24. The energy storage device of claim 22, wherein the device has a specific capacity as determined by cycling stability study, after at least 500 electrochemical cycles, of at least 40% of its specific capacity after the first cycle.

25. The energy storage device of claim 22, wherein the device has specific capacity as determined by cycling stability study, after at least 500 electrochemical cycles, of at least 60% of its specific capacity after the first cycle.

26. The energy storage device of claim 22, wherein the device is a secondary battery.

27. The energy storage device of claim 26, wherein the secondary battery is a Lithium ion battery.

28. An energy storage device comprising: at least one electrode and an electrolyte wherein the at least one electrode comprises:
(a) a polymeric resin; (b) a capacity retaining agent; (c) an electrode active agent; and (d) optionally a binding agent, wherein the capacity retaining agent retains the specific capacity of the electrode, after 500 electrochemical cycles, in the range of 20-80% of its specific capacity after the first cycle.

29. The energy storage device of claim 28, wherein the capacity retaining agent is represented by the formula: 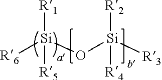
where R¹′, R²′, R³′, R⁴′, R⁵′, and R⁶′ are each independently R⁴, OR⁵, or a ureido functional group, where R⁴ is independently a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, and an aryl group having 6 to 20 carbon atoms, or an aralkyl having 7 to 20 carbon atoms;
R⁵ is independently a straight chain alkyl having 1 to 12 carbon atoms, a branched chain alkyl having 3 to 12 carbon atoms, a cycloalkyl having 5 to 12 carbon atoms, an alkenyl having 2 to 12 carbon atoms, an aryl group having 6 to 20 carbon atoms, or an aralkyl having 7 to 20 carbon atoms;
a′ or b′ is an integer having a value in the range of 0-500, with the proviso that at least one of these a′ or b′ is >0; and
at least one of R¹′, R²′, R³′, R⁴′, R⁵′, and/or R⁶′ is a ureido functional group.

30. The energy storage device of claim 29, wherein the ureido functional group is represented by the formula: 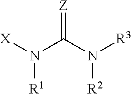
where R¹ and R² are each independently selected from the group consisting of hydrogen and a monovalent organic group having 1 to 20 carbon atoms;
R³ is a divalent straight chain alkylene group having 1 to 20 carbon atoms, or a divalent branched alkylene group having 3 to 20 carbon atoms, each of which optionally contains one or more heteroatoms within the chain;
X is selected from the group consisting of a substituted or unsubstituted aromatic group having 6 to 20 carbon atoms and a heterocyclic group containing 1 to 20 heteroatoms, wherein the aromatic group and/or the heterocyclic group are optionally substituted with an alkyl group having from 1 to 12 carbon atoms optionally containing a heteroatom selected from the group consisting of O, N, and/or S and a ureido functional group; and
Z is oxygen.

31. An electrode comprising the composition of any claim 1.

32. An electrochemical cell comprising a negative electrode, and a positive electrode, wherein the negative electrode, the positive electrode, or both the negative and positive electrode comprise the composition of claim 22.

33. The electrochemical cell of claim 32 further comprising a separator.

34. The electrochemical cell of claim 32, wherein the electrochemical cell is a lithium ion battery.
